(19) United States
(12) Patent Application Publication
(10) Pub. No.: US 2009/0046927 A1
(43) Pub. Date: Feb. 19, 2009

(54) METHOD AND APPARATUS FOR REDUCING NOISE IN IMAGE

(75) Inventor: SHOU-CHIH CHIANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/959,220

(22) Filed: Dec. 18, 2007

(30) Foreign Application Priority Data
Aug. 15, 2007 (CN) 200710201371.6

(51) Int. Cl. G06K 9/00

(52) U.S. Cl. 382/167

(57) ABSTRACT

An exemplary method for reducing noise in an image is disclosed. The image comprises a number of pixels including a current pixel that contains noise. The method comprises: measuring a value of each of the pixels; calculating a number of variances of value of a number of pixel areas, each of which includes the current pixel and lies in a unique orientation with respect to the current pixel, based on the measured values; calculating the mean of value of the pixel area associated with the current pixel and having the smallest variance of value, based on the measured values; and replacing the value of the current pixel with the calculated mean of value.

### BACKGROUND

1. Technical Field

Aspects of the present invention relate to image processing technology and, particularly, relate to a method and an apparatus for reducing noise in an image.

2. Description of Related Art

In general, images unavoidably contain noise in the form of occasional pixels with values that are too high or too low in color and luminance. This noise appears as random speckles on an otherwise smooth surface, and significantly degrades image quality. Therefore, many techniques, such as, mean filters or median filters, have been proposed to remove noise in an image, but always end up softening the image (blurring the edge of the image) as well.

Therefore, it is desirable to provide a method and an apparatus for removing noise in an image, which can overcome the abovementioned problems.

### SUMMARY

In a present embodiment, a method for reducing noise in an image is disclosed. The image comprises a number of pixels including a current pixel that contains noise. The method comprises: measuring a value of each of the pixels; calculating a number of variances of value of a number of pixel areas, each of which includes the current pixel and lies in a unique orientation with respect to the current pixel, based on the measured values; calculating the mean value of the pixel area associated with the current pixel and having the smallest variance of value, based on the measured values; and replacing the value of the current pixel with the calculated mean value.

### BRIEF DESCRIPTION OF THE DRAWINGS

Many aspects of the present embodiments should be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a functional block diagram of an apparatus for reducing noise in an image, according to an exemplary embodiment.

FIG. 2 is a flow chart of a method for reducing noise in an image, according to another exemplary embodiment.

FIG. 3 is a schematic view showing a principle of the method of FIG. 2.

### DETAILED DESCRIPTION OF THE EMBODIMENTS

Embodiments of the present apparatus and method will now be described in detail with reference to the drawings.

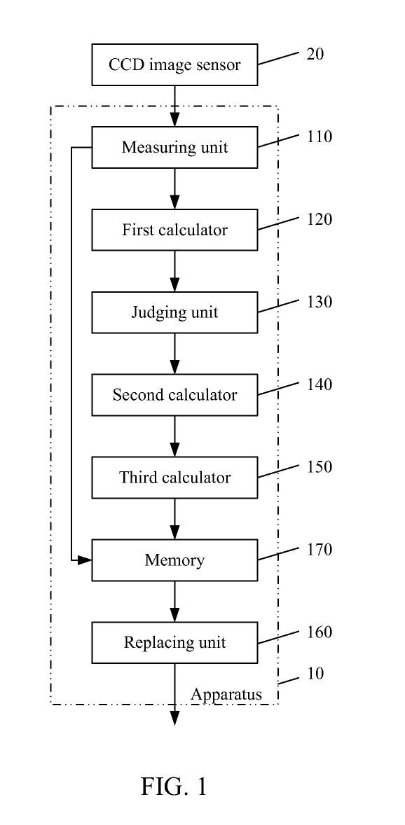

Referring to FIG. 1, an apparatus 10 is configured to remove noise in an image while preserving the edge of the image. The image can be a RAW image file directly transmitted from image sensors, such as, coupled charge device (CCD) image sensors or complementary metal oxide semiconductor (CMOS) image sensors, or a JPEG/TIFF image file transformed from a RAW image file and stored in any readable/accessible storage device. As illustrated in FIG. 1, the image of this embodiment is assumed to be directly generated by, e.g., a CCD image sensor 20, and is, as well known, composed of three color components, for example, red (R), green (G), and blue (B) components (that is, each pixel of the image is represented by three color values: R, G, and B).

The apparatus 10 includes a measuring unit 110, a first calculator 120, a judging unit 130, a second calculator 140, a third calculator 150, and a replacing unit 160. The measuring unit 110 is configured to measure, for example, R of each pixel of the image. The first calculator 120 is configured to calculate the mean and variance of R of a first pixel area including a current pixel based on the measured R values. The judging unit 130 is configured to judge whether the R value of the current pixel is in a range from ‘ v̅−1σ’ to ‘ v̅+1σ, if yes, the current pixel is a normal pixel, if no, the current pixel contains noise, where ‘ v̅ and ‘σ’ respectively represent the mean and variance of R of the first area associated with the current pixel, and ‘1’ is a positive number, and satisfies the equation: 0<1<3. The second calculator 140 is configured to calculate a number of variances of R of a number of second pixel areas, each of which includes the current pixel and lies in a unique orientation with respect to the current pixel, based on the measured R value, if the current pixel contains noise. The third calculator 150 is configured to calculate the mean of R value of the second pixel area associated with the current pixel that has the smallest variance based on the measured R values, if the current pixel contains noise. The replacing unit 160 is configured to replace the R value of each pixel that contains noise with the respective calculated mean of R of the selected second pixel area.

Opportunely, the apparatus 10 further includes a memory 170. The measured R values, and the calculated means of R of second pixel areas are stored in the memory 170, and the replacing unit 160 reads the measured R values, and the calculated means of R of the selected second pixel area from the memory 170 for replacement.

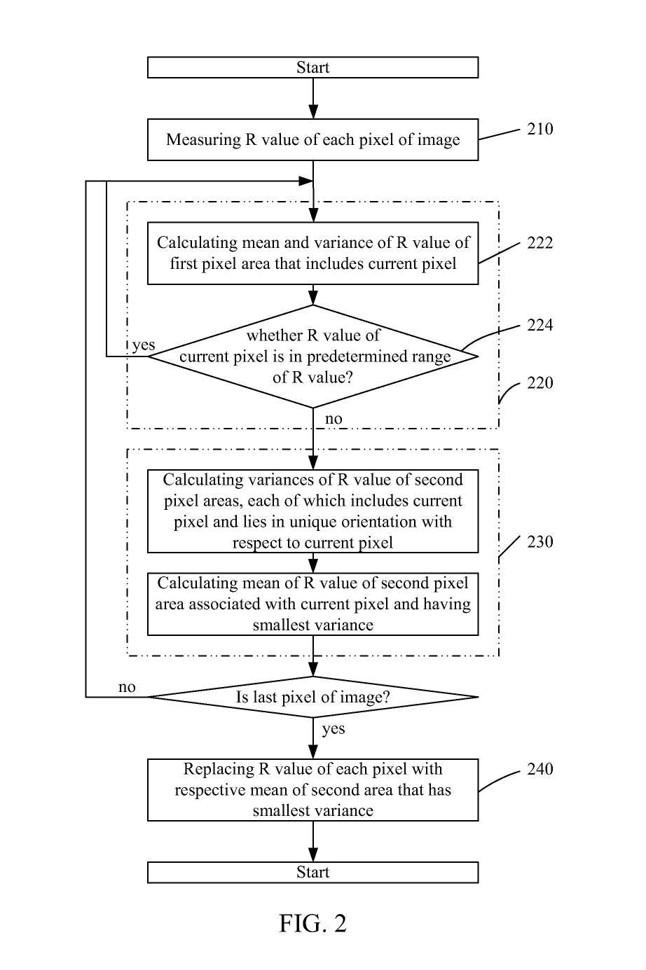

Referring to FIG. 2, a method for reducing noise in an image includes the following operations 210˜240.

Operation 210: measuring R of each pixel of the image. Specifically, this operation can be carried out by the measuring unit 110. Next, the measured R values are stored in the memory 170.

Operation 220: judging whether a current pixel contains noise. One exemplary technique of this operation is realized by:

sub-operation 222: calculating the mean and variance of R of a first pixel area that includes the current pixel based on the measured R values; and

sub-operation 224: judging whether R of the current pixel is in a range from ‘ v̅−1σ’ to ‘ v̅+1σ’, where ‘ v̅’ and ‘σ’ respectively represent the mean and variance of R of the first area associated with the current pixel, and ‘1’ is a positive number, that satisfies the equation: 0<1<3, and can be determined based on the quality requirements of the image. Specifically, the sub-operations 222 (the calculating sub-operation), 224 (the judging sub-operation) can be respectively carried out by the first calculator 120 and the judging unit 130.

The above technique is based upon the fact that a distribution of values (e.g., R, G, B, or brightness values) of a pixel area is typically predictable. Accordingly, the value of R of normal pixels in a first pixel area must be in the range from ‘ v̅−1σ’ to ‘ v̅+1σ’. Therefore, if the operation 224 (the judging operation) yields ‘yes’, the current pixel is a normal pixel, in this case, the method selects a next pixel as a new current pixel and goes to the sub-operation 222 (the calculating sub-operation) or goes to the operation 240 if there is no next pixel (that is, the current pixel is the last pixel of the image), if ‘no’, the current pixel contains noise, the method goes to the operation 230.

Operation 230: calculating a number of variances in the values of R of a number of second pixel areas, each of which includes the current pixel and lies on a unique orientation with respect to the current pixel, based on the measured values of R, and calculating the mean of R of the second pixel area associated with the current pixel and having the smallest variance based on the measured values of R. This operation can be carried out by the second calculator 140 and third calculator 150. Next, the calculated mean is stored in the memory 170, and the method selects a next pixel as a new current pixel and goes to the sub-operation 222 (the calculating sub-operation), or goes to the operation 240 if the current pixel is the last pixel of the image.

Operation 240: replacing the value of R of each pixel that contains noise with the respective calculated mean of R of the corresponding selected second pixel area. This operation can be carried out by the replacing unit 150.

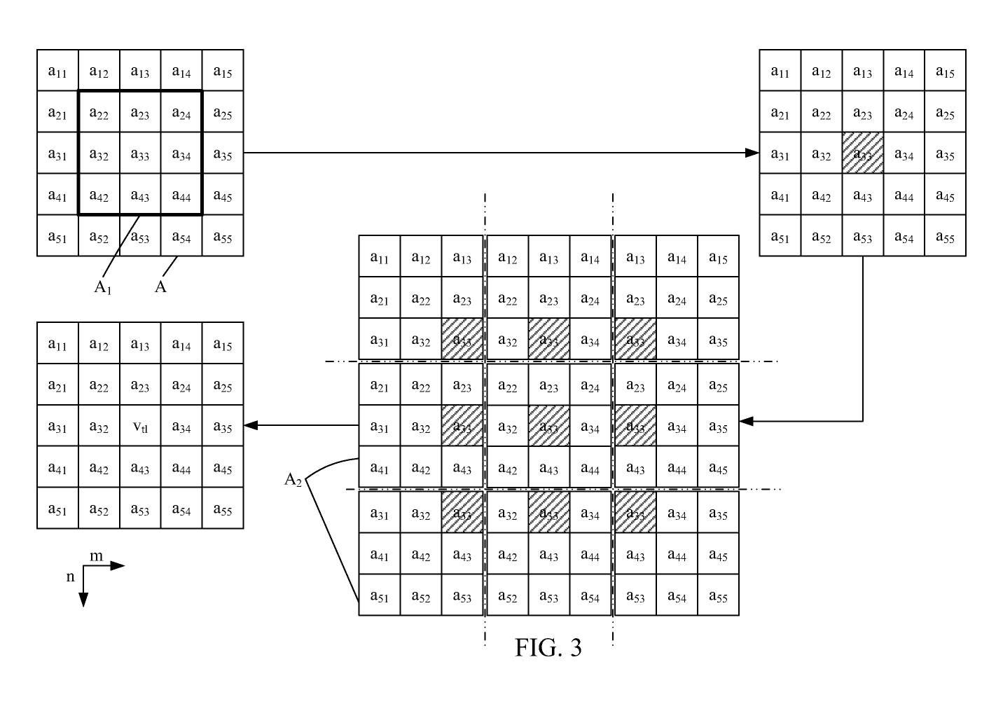

Referring to FIG. 3, a more detailed description of the method is given below to provide a better understanding of the exemplary embodiment.

As illustrated in FIG. 3, ‘A’ is the R component of the image (the array of the measured R values), aₘₙ is the R value of a pixel of the image at the intersection of line n and row m (m, n are positive integers). In this description, the central pixel with a₃₃ is assumed to be the current pixel, and contains noise. The first calculator 120 calculates the mean and variance of R of the first pixel area A₁, as illustrated in FIG. 3, including the current pixel and eight pixels surrounding the current pixel (3×3 pixels). The judging unit 130 judges whether the current pixel contains noise, and yields, for example, ‘yes’. Next, the second calculator 140 calculates nine variances of R among nine second pixel areas, as illustrated in FIG. 3, each of which includes 3×3 pixels, and lies in a unique orientation, e.g., center, top, top left, left, foot, left foot, right foot, right, and top right, with respect to the current pixel. It also assumed that the second pixel area lying in top left orientation has the smallest variance, so, the third calculator 150 calculates the mean of value of the top left second pixel area, and yields ‘vₜₗ’. After all pixels have been done, the replacing unit 160 replaces a₃₃ with vₜₗ. It should be understood that though only twenty-five (5×5) pixels are shown in FIG. 3, the number of pixels of an actual image is usually far greater than twenty-five. It also should be understood that the first pixel area Al and the second pixel area A₂ are not limited to the detailed description, but can take other forms, e.g., pixel array of other size (e.g., 5×5), or other geometric shape.

It should be understood that pixel areas describing the edge of the image should have a large variance and pixel areas describing a same textured portion of the image should have a small variance. According to aforementioned, if the current pixel contains noise, the method and the apparatus 10 will replace the R value of the current pixel with the mean of R of the portion of the image the current pixel should belong to, which avoids over-correcting R according to values of R in a much different portion of the image as occurs using a conventional mean filter or median filter, in this way, the edge of the image is preserved.

It is to be understood that, noise not only in R component but in all components, e.g., G component, B component, or brightness component, of the image can be removed by the method and apparatus.

Various components of the apparatus 10, as shown in FIG. 1, such as the measuring unit 110, the first calculator 120, the judging unit 130, the second calculator 140, the third calculator 150, and the replacing unit 160 can be integrated into a single control unit, or alternatively, can be implemented in software algorithm or hardware, such as, for example, a field programmable gate array (FPGA) or an application specific integrated circuit (ASIC). In addition, method operations of FIG. 2 may be performed by the same control unit or a processor executing instructions organized into a program module or a custom designed state machine. As such, it is intended that the processes described herein be broadly interpreted as being equivalently performed by software, hardware, or a combination thereof. As previously discussed, software modules can be written, via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. Accordingly, it is intended, therefore, that the present invention not be limited to the various example embodiments disclosed, but that the present invention includes all embodiments falling within the scope of the appended claims.

What is claimed is:

1. A method for reducing noise in an image, the image comprising a plurality of pixels, the method comprising:
measuring a value of each of the pixels;
judging whether a current pixel contains noise;
calculating a plurality of variances of value of a plurality of second pixel areas, each of which includes the current pixel and lies in a unique orientation with respect to the current pixel; and calculating the mean of the second pixel area that is associated with the current pixel area and has the smallest variance, if the current pixel contains noise; and
replacing the value of each pixel that contains noise with the respective calculated mean of second pixel area.

2. The method as claimed in claim 1, wherein the values of the image are measured in an image component selected from a group of: red component, green component, blue component, and brightness component.

3. The method as claimed in claim 1, further comprising:
storing the measured values.

4. The method as claimed in claim 1, wherein judging whether a current pixel contains noise comprises:
calculating the mean and variance of value of a pixel area that includes the current pixel; and
judging whether the value of the current pixel is in a range of value from ‘ v̅−1σ’ to ‘ v̅+1σ’, if yes, the current pixel is a normal pixel, if no, the current pixel contains noise, where ‘ v̅’ and ‘σ’ respectively represent the mean and variance of value of the first area associated with the current pixel, and ‘1’ is a positive number, satisfies the equation: 0<1<3.

5. The method as claimed in claim 4, wherein the first pixel area is a pixel array selected from a group of: 3×3 array and 5×5 array.

6. The method as claimed in claim 1, wherein the second pixel areas associated with a current pixel respectively lie in the center, top, top left, left, foot, left foot, right foot, right, and top right orientation with respect to the current pixel.

7. The method as claimed in claim 1, wherein the second pixel area is pixel array selected from a group of: 3×3 array and 5×5 array.

8. The method as claimed in the claim 1, further comprising:
storing each calculated mean of second pixel area with association-ship with the respective pixel of the image.

9. A method for removing noise in an image, the image comprising a plurality of pixels including a current pixel that contains noise, the method comprising:
measuring a value of each of the pixels;
calculating a plurality of variances of value of a plurality of pixel areas, each of which including the current pixel and lying in a unique orientation with respect to the current pixel, based on the measured values;
calculating the mean of value of the pixel area with the smallest variance of value, based on the measured values; and
replacing the value of the current pixel by the calculated mean of value.

10. The method as claimed in claim 9, wherein the values of the image are measured in an image component selected from a group of: red component, green component, blue component, and brightness component.

11. The method as claimed in claim 9, wherein the second pixel areas associated with a current pixel respectively lie in the center, top, top left, left, foot, left foot, right foot, right, and top right orientation with respect to the current pixel.

12. The method as claimed in claim 9, wherein the second pixel area is pixel array selected from a group of: 3×3 array and 5×5 array.

13. An apparatus for removing noise in an image, the image comprising a plurality of pixels, the apparatus comprising:
a measuring unit configured to measure a value of each of the pixels;
a first calculator configured to calculate the mean and variance of value of a first pixel area including a current pixel;
a judging unit configured to judge whether the value of the current pixel is in a range of value from ‘ v̅−1σ’ to ‘ v̅+1σ’, if yes, the current pixel is a normal pixel, if no, the current pixel contains noise, where ‘ v̅’ and ‘σ’ respectively represent the mean and variance of value of the first area associated with the current pixel, and ‘1’ is a positive number, and satisfies the equation: 0<1<3;
a second calculator configured to calculate a plurality of variances of value of a plurality of second pixel areas, each of which includes the current pixel and lies in a unique orientation with respect to the current pixel, if the current pixel contains noise;
a third calculator configured to calculate the mean of value of the second pixel area that is associated with the current pixel and has the smallest variance, if the current pixel contains noise; and
a replacing unit configured to replace the value of each pixel that contains noise with the respective calculated mean of value of second pixel area.

14. The apparatus as claimed in claim 13, wherein the values of the image are measured in an image component selected from a group of: red component, green component, blue component, and brightness component.

15. The apparatus as claimed in claim 13, wherein the first pixel area is pixel array selected from a group of: 3×3 array and 5×5 array.

16. The apparatus as claimed in claim 13, wherein the second pixel areas associated with a current pixel respectively lie in the center, top, top left, left, foot, left foot, right foot, right, and top right orientation with respect to the current pixel.

17. The apparatus as claimed in claim 13, wherein the second pixel area is pixel array selected from a group of: 3×3 array and 5×5 array.

18. The apparatus as claimed in claim 13, further comprising a memory, the memory being configured for storing the measured values, and the calculated means of R value of second pixel areas, each of which is associated with a respective pixel that contains noise, the replacing unit reading the measured values, and the calculated means of R value of second pixel area with association-ship from the memory for replacement.

19. A method for reducing noise in an image, the image comprising a matrix of pixels, the method comprising:
measuring brightness component of each of the pixels;
judging whether each of the pixels contains noise, if a given pixel contains noise, choosing a number of N² distinct N times N arrays of N² pixels, each of which includes the given pixel, N being an integer greater than 2;
calculating a variance of the brightness component of each of the N times N arrays; calculating a mean of the brightness component of the N² pixels of the N times N array which has the least variance; and
replacing the brightness component of the given pixel with the mean of the brightness component of the N² pixels of the N times N array which has the least variance.
